(19) United States
(12) Patent Application Publication
(10) Pub. No.: US 2007/0237986 A1
(43) Pub. Date: Oct. 11, 2007

(54) Perpendicular magnetic recording media without soft magnetic underlayer and method of fabricating same

(75) Inventors: Zhong (Stella) Wu, Fremont, CA (US); Samuel Dacke Harkness IV, Berkeley, CA (US); Erol Girt, Berkeley, CA (US); Qixu Chen, Milpitas, CA (US); Thomas P. Nolan, Fremont, CA (US)

Correspondence Address: SEAGATE TECHNOLOGY LLC;c/o MCDERMOTT WILL & EMERY LLP, 600 13TH STREET, NW, WASHINGTON, DC, 20005-3096, US

(73) Assignee: SEAGATE TECHNOLOGY LLC

(21) Appl. No.: 11/399,507

(22) Filed: Apr. 7, 2006

(51) Int. Cl. G11B 5/66

(52) U.S. Cl. 428/831.2

(57) ABSTRACT

A perpendicular magnetic recording medium comprises a non-magnetic substrate having a planar surface and a stack of thin film layers overlying the substrate surface and including at least one perpendicular magnetic recording layer with a magnetic easy axis perpendicular to the plane of the layer stack, wherein a magnetically soft underlayer (“SUL”) is not present in the layer stack. The layer stack includes a first, amorphous and smooth-surfaced underlayer proximal the substrate surface, a second underlayer having a first crystallographic orientation overlying the first underlayer, a third underlayer having a second crystallographic orientation overlying the second underlayer, and at least one perpendicular magnetic recording layer having a crystallographic orientation similar to the second crystallographic orientation overlying the third underlayer.

### FIELD OF THE DISCLOSURE

The present invention relates to improved perpendicular magnetic recording media and methods for fabricating same. The invention has particular utility in the manufacture of very high to ultra-high areal recording density media, e.g., hard disks, utilizing granular perpendicular-type magnetic recording layers.

### BACKGROUND OF THE DISCLOSURE

Magnetic media are widely used in various applications, particularly in the computer industry for data/information storage and retrieval applications, typically in disk form, and efforts are continually made with the aim of increasing the areal recording density, i.e., bit density of the magnetic media. Conventional thin film thin-film type magnetic media, wherein a fine-grained polycrystalline magnetic alloy layer serves as the active recording layer, are generally classified as “longitudinal” or “perpendicular”, depending upon the orientation of the magnetic domains of the grains of magnetic material.

Perpendicular recording media have been found to be superior to longitudinal media in achieving very high bit densities without experiencing the thermal stability limit associated with the latter. In perpendicular magnetic recording media, residual magnetization is formed in a direction (“easy axis”) perpendicular to the surface of the magnetic medium, typically a layer of a magnetic material on a suitable substrate. Very high to ultra-high linear recording densities are obtainable by utilizing a “single-pole” magnetic transducer or “head” with such perpendicular magnetic media.

At present, efficient, high bit density recording utilizing a perpendicular magnetic medium requires interposition of a relatively thick (as compared with the magnetic recording layer), magnetically “soft” underlayer (“SUL”), i.e., a magnetic layer having a relatively low coercivity below about 1 kOe, such as of a NiFe alloy (Permalloy), between a non-magnetic substrate, e.g., of glass, aluminum (Al) or an Al-based alloy, and a magnetically “hard” recording layer having relatively high coercivity, typically about 3-8 kOe, e.g., of a cobalt-based alloy (e.g., a Co—Cr alloy such as CoCrPtB) having perpendicular anisotropy. The magnetically soft underlayer serves to guide magnetic flux emanating from the head through the magnetically hard perpendicular recording layer.

A typical conventional perpendicular recording system 10 with a perpendicularly oriented magnetic medium 1, having a relatively thick magnetically soft underlayer (SUL) 4, a relatively thin hard magnetic recording layer 6, and a magnetic transducer head 9, is illustrated in FIG. 1, wherein reference numeral 2 indicates a non-magnetic substrate, reference numeral 3 indicates an optional adhesion layer formed on surface 2_{A} of substrate 2, reference numeral 4 indicates a magnetically soft underlayer (SUL), reference numeral 5 indicates at least one non-magnetic seed layer (sometimes referred to as an “intermediate” layer or as an “interlayer”), and reference numeral 6 indicates at least one magnetically hard perpendicular recording layer with its magnetic easy axis perpendicular to the film plane.

Still referring to FIG. 1, reference numerals 9_{M} and 9_{A}, respectively, indicate the main (writing) and auxiliary poles of the magnetic transducer head 9. The relatively thin interlayer 5, comprised of one or more layers of non-magnetic materials, serves to (1) prevent magnetic interaction between the magnetically soft underlayer 4 and the at least one magnetically hard recording layer 6; and (2) promote desired microstructural and magnetic properties of the at least one magnetically hard recording layer 6.

As shown by the arrows in the figure indicating the path of the magnetic flux θ, flux θ emanates from the main writing pole 9_{M} of magnetic transducer head 9, enters and passes through the at least one vertically oriented, magnetically hard recording layer 6 in the region below main pole 9_{M}, enters and travels within soft magnetic underlayer (SUL) 4 for a distance, and then exits therefrom and passes through the at least one perpendicular hard magnetic recording layer 6 in the region below auxiliary pole 9_{A} of transducer head 9. The direction of movement of perpendicular magnetic medium 21 past transducer head 9 is indicated in the figure by the arrow in the figure.

Completing the layer stack of medium 1 is a protective overcoat layer 7, such as of a diamond-like carbon (DLC), formed over magnetically hard layer 6, and a lubricant topcoat layer 8, such as of a perfluoropolyether (PFPE) material, formed over the protective overcoat layer.

Substrate 2 is typically disk-shaped and comprised of a non-magnetic metal or alloy, e.g., Al or an Al-based alloy, such as Al—Mg having a Ni—P plating layer on the deposition surface thereof, or alternatively, substrate 2 is comprised of a suitable glass, ceramic, glass-ceramic, polymeric material, or a composite or laminate of these materials. Optional adhesion layer 3, if present, may comprise an up to about 200 Å thick layer of a material such as Ti, a Ti-based alloy, Cr, or a Cr-based alloy. Soft magnetic underlayer 4 is typically comprised of an about 50 to about 150 nm thick layer of a soft magnetic material selected from the group consisting of Ni, NiFe (Permalloy), Co, CoZr, CoZrCr, CoZrNb, CoFeZrNb, CoFe, Fe, FeN, FeSiAl, FeSiAlN, FeCoB, FeCoC, etc. Interlayer 5 typically comprises an up to about 300 Å thick layer or layers of non-magnetic material(s), such as Ru, TiCr, Ru/CoCr₃₇Pt₆, RuCr/CoCrPt, etc.; and the at least one magnetically hard perpendicular recording layer 6 is typically comprised of an about 50 to about 250 Å thick layer(s) of Co-based alloy(s) including one or more elements selected from the group consisting of Cr, Fe, Ta, Ni, Mo, Pt, V, Nb, Ge, B, and Pd.

A problem associated with the fabrication of perpendicular media, such as medium 1 described above, is difficulty in forming perpendicular, magnetically hard recording layers 6 with a desired crystallographic orientation and film quality for perpendicular orientation of the magnetic easy axis, e.g., an hcp (0002) orientation. More specifically, perpendicular magnetic recording layers 6 fabricated according to conventional methodology without an underlying magnetically soft underlayer (SUL) 4 having (0002) orientation frequently exhibit a very large crystallographic distribution resulting in generation of a large amount of noise during the data writing/reading process. In addition, such perpendicular magnetic recording layers 6 fabricated according to conventional methodology exhibit poor magnetic properties.

In addition, manufacture of perpendicular magnetic recording media with a thick magnetically soft underlayer (SUL) adds a large amount of complexity to the manufacturing process due to the requirement for the thick film SUL to be sputter deposited in a short interval compatible with the requirement for maintaining high product throughput. Further in addition, the thick film sputter deposition process disadvantageously results in excessive coating of the interior surfaces of the vacuum chambers and associated components of the sputtering equipment, resulting in increased down-time for cleaning of the manufacturing apparatus.

In view of the foregoing, there exists a clear need for perpendicular magnetic media designs, and fabrication methods therefor, which designs and methods do not require presence of a SUL in the layer stack while affording perpendicular recording layers with excellent crystallographic orientation and magnetic properties.

### SUMMARY OF THE DISCLOSURE

An advantage of the present disclosure is improved perpendicular magnetic recording media.

Another advantage of the present disclosure is improved perpendicular magnetic recording media without a magnetically soft underlayer (SUL).

Still another advantage of the present disclosure is an improved method of fabricating perpendicular magnetic recording media.

Additional advantages and other features of the present disclosure will be set forth in the description which follows and in part will become apparent to those having ordinary skill in the art upon examination of the following or may be learned from the practice of the present invention. The advantages of the present disclosure may be realized and obtained as particularly pointed out in the appended claims.

According to an aspect of the present disclosure, the foregoing and other advantages are obtained in part by an improved perpendicular magnetic recording medium, comprising:

(a) a non-magnetic substrate having a planar surface; and

(b) a stack of thin film layers overlying the planar surface of the substrate and including at least one perpendicular magnetic recording layer with a magnetic easy axis perpendicular to the plane of the layer stack, wherein a magnetically soft underlayer (“SUL”) is not present in the layer stack.

In accordance with embodiments of the present disclosure, the layer stack includes first, second, and third underlayers beneath the at least one perpendicular magnetic recording layer; wherein the first underlayer is proximal the substrate and is amorphous with a smooth surface; the second underlayer overlies the first underlayer and has a first crystallographic orientation; the third underlayer overlies the second underlayer and has a second crystallographic orientation; and the at least one perpendicular magnetic recording layer overlies the third underlayer and has a crystallographic orientation similar to the second crystallographic orientation.

Preferably, the first crystallographic orientation is fcc; the second crystallographic orientation is hcp; and the at least one perpendicular magnetic recording layer has an hcp (0002) crystallographic orientation.

Embodiments of the present disclosure include those wherein the first underlayer (which may comprise a plurality of amorphous layers) is from about 30 to about 1,000 Å thick and comprises 20-90 at. % Cr and up to about 80 at. % of at least one element selected from the group consisting of Ta, Ti, Zr, Nb, Hf, V, Mo, and W; the second underlayer is from about 5 to about 400 Å thick, comprises an element selected from the group consisting of Ag, Pt, Pd, Cu, and Au, and the first crystallographic orientation is fcc (111); the third underlayer is from about 1 monolayer to about 500 Å thick and comprises Ru or a Ru-based alloy; the at least one perpendicular magnetic recording layer is from about 30 to about 350 Å thick and comprises Co and at least one element selected from the group consisting of Cr, Ni, Pt, Ta, B, Nb, O, Ti, Si, Mo, B, Cu, Ag, Ge, and Fe; the substrate comprises a non-magnetic material selected from the group consisting of Al, Al—Mg alloy, other Al-based alloys, Ni—P plated Al or Al-based alloys, glass, ceramic, glass-ceramic, polymeric material, and composites or laminates of these materials; and the layer stack includes a protective overcoat layer overlying said perpendicular magnetic recording layer and a lubricant topcoat layer overlying the protective overcoat layer.

Another aspect of the present disclosure is an improved method of fabricating a perpendicular magnetic recording medium, comprising steps of:

(a) providing a non-magnetic substrate having a planar surface; and

(b) forming a stack of thin film layers overlying the planar surface of the substrate and including at least one perpendicular magnetic recording layer with a magnetic easy axis perpendicular to the plane of the layer stack, wherein a magnetically soft underlayer (“SUL”) is not present in the layer stack.

According to embodiments of the present disclosure, step (b) comprises forming the layer stack with first, second, and third underlayers beneath the at least one perpendicular magnetic recording layer, wherein step (b) comprises forming the layer stack such that said first underlayer is proximal the substrate surface and is amorphous with a smooth surface; the second underlayer overlies the first underlayer and has a first crystallographic orientation; the third underlayer overlies the second underlayer and has a second crystallographic orientation; and the at least one perpendicular magnetic recording layer overlies the third underlayer and has a crystallographic orientation similar to the second crystallographic orientation.

Preferably, step (b) comprises forming the layer stack such that the first crystallographic orientation is fcc; the second crystallographic orientation is hcp; and the at least one perpendicular magnetic recording layer has a hcp (0002) crystallographic orientation.

Embodiments of the present disclosure include those wherein the layer stack formed in step (b) is such that the first underlayer is from about 30 to about 1,000 Å thick and comprises 20-90 at. % Cr and up to about 80 at. % of at least one element selected from the group consisting of Ta, Ti, Zr, Nb, Hf, V, Mo, and W; the second underlayer is from about 5 to about 400 Å thick, comprises an element selected from the group consisting of Ag, Pt, Pd, Cu, and Au, and the first crystallographic orientation is fcc (111); the third underlayer is from about 1 monolayer to about 500 Å thick and comprises Ru or a Ru-based alloy; and the at least one perpendicular magnetic recording layer is from about 30 to about 350 Å thick and comprises Co and at least one element selected from the group consisting of Cr, Ni, Pt, Ta, B, Nb, O, Ti, Si, Mo, B, Cu, Ag, Ge, and Fe.

According to embodiments of the present disclosure, step (a) comprises providing a substrate comprised of a non-magnetic material selected from the group consisting of Al, Al—Mg alloy, other Al-based alloys, Ni—P plated Al or Al-based alloys, glass, ceramic, glass-ceramic, polymeric material, and composites or laminates of these materials; and the method further comprises steps of:

(c) forming a protective overcoat layer over the perpendicular magnetic recording layer; and

(d) forming a lubricant topcoat layer over the protective overcoat layer.

Yet another aspect of the present disclosure is an improved perpendicular magnetic recording medium, comprising:

(a) a non-magnetic substrate having a planar surface; and

(b) a stack of thin film layers overlying the planar surface of the substrate, the layer stack including:

(i) a first underlayer in overlying contact with the planar surface, comprising Cr and at least one element selected from the group consisting of Ta, Ti, Zr, Nb, Hf, V, Mo, and W;

(ii) a second underlayer in overlying contact with the first underlayer, comprising an element selected from the group consisting of Ag, Pt, Pd, Cu, and Au;

(iii) a third underlayer in overlying contact with the second underlayer, comprising Ru or a Ru-based alloy; and

(iv) at least one perpendicular magnetic recording layer with a magnetic easy axis perpendicular to the plane of the layer stack in overlying contact with said third underlayer, comprising Co and at least one element selected from the group consisting of Cr, Ni, Pt, Ta, B, Nb, O, Ti, Si, Mo, B, Cu, Ag, Ge, and Fe.

In accordance with embodiments of the present disclosure, the first underlayer is amorphous with a smooth surface; the second underlayer has a first crystallographic orientation; the third underlayer has a second crystallographic orientation; and the at least one perpendicular magnetic recording layer has a crystallographic orientation similar to the second crystallographic orientation.

Preferably, the first crystallographic orientation is fcc; the second crystallographic orientation is hcp; and the at least one perpendicular magnetic recording layer has an hcp (0002) crystallographic orientation.

Additional advantages and aspects of the present disclosure will become readily apparent to those skilled in the art from the following detailed description, wherein embodiments of the present disclosure are shown and described, simply by way of illustration of the best mode contemplated for practicing the present disclosure. As will be described, the present disclosure is capable of other and different embodiments, and its several details are susceptible of modification in various obvious respects, all without departing from the spirit of the present disclosure. Accordingly, the drawings and description are to be regarded as illustrative in nature, and not as limitative.

### BRIEF DESCRIPTION OF THE DRAWINGS

The following detailed description of the embodiments of the present disclosure can best be understood when read in conjunction with the following drawings, in which the same reference numerals are employed throughout for designating the same or similar features, and wherein the various features are not necessarily drawn to scale but rather are drawn as to best illustrate the pertinent features, wherein:

FIG. 1 schematically illustrates, in simplified cross-sectional view, a portion of a magnetic recording, storage, and retrieval system 10 according to the conventional art, comprised of a perpendicular magnetic recording medium 1 and a single pole transducer head 9;

FIG. 2 schematically illustrates, in simplified cross-sectional view, a portion of an improved perpendicular magnetic recording medium 11 according to the present disclosure;

FIG. 3 is a graph illustrating a θ-2θ X-ray diffraction scan of a CoPtOₓ perpendicular magnetic recording layer of a medium according to FIG. 2;

FIG. 4 is a graph illustrating an X-ray rocking curve scan of the CoPtOₓ perpendicular magnetic recording layer of a medium according to FIG. 2; and

FIG. 5 is a graph illustrating a MOKE loop of a perpendicular magnetic recording medium according to FIG. 2.

### DETAILED DESCRIPTION OF THE DISCLOSURE

The present disclosure addresses and solves problems, disadvantages, and drawbacks associated with the requirement for including a relatively thick magnetically soft underlayer (SUL) in conventional perpendicular magnetic recording media designs, and is based upon recognition that a key function of the SUL, in addition to providing a closed path for the magnetic field from the single-pole recording head as shown in FIG. 1, is to provide a surface morphology which promotes formation thereover of a perpendicular magnetic recording layer having a desired high quality crystallographic orientation, i.e., with a narrow range or distribution of crystallographic orientations.

More specifically, investigations have determined that an amorphous SUL is necessary for subsequent formation thereon of a high quality magnetic recording layer with a desired orientation, e.g., an hcp (0002) orientation, of the magnetic easy axis perpendicular to the plane of the layer. In particular, it has been determined that, in the absence of an amorphous SUL, a desired hcp (0002) orientation of the magnetic easy axis is of poor quality, with a very large crystallographic distribution. Magnetic media containing such poor quality magnetic recording layers exhibit extremely large amounts of recording noise during the data writing/reading process. In addition, it has been determined that poor (0002) orientations of any underlayers present between the SUL and the perpendicular magnetic recording layer result in poor magnetic properties of the latter.

The present disclosure includes description of the design and fabrication of perpendicular magnetic recording media with perpendicular magnetic recording layers with high quality crystallographic orientations and which do not require a SUL. According to embodiments of the present disclosure, perpendicular magnetic recording media are fabricated with a layer stack including first, second, and third underlayers beneath the at least one perpendicular magnetic recording layer, wherein the first underlayer is proximal the media substrate and is amorphous with a smooth surface, the second underlayer overlies the first underlayer and has a first crystallographic orientation, the third underlayer overlies the second underlayer and has a second crystallographic orientation, and the at least one perpendicular magnetic recording layer overlies the third underlayer and has a crystallographic orientation similar to the second crystallographic orientation. By way of illustration, but not limitation, the first crystallographic orientation is fcc, the second crystallographic orientation is hcp, and the at least one perpendicular magnetic recording layer has a very high quality hcp (0002) crystallographic orientation.

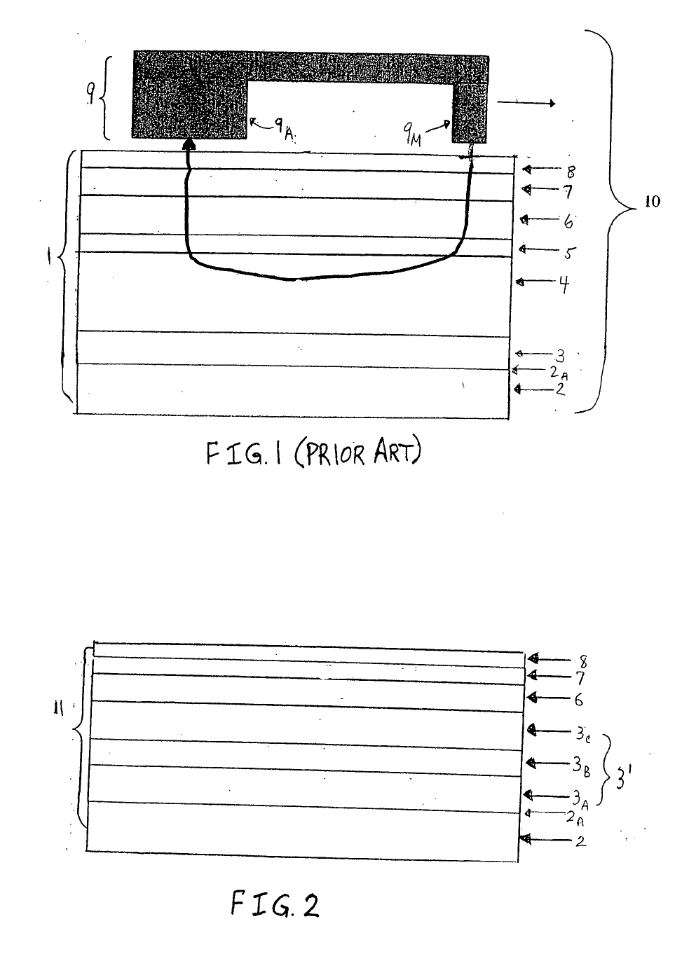

Referring to FIG. 2, schematically illustrated therein, in simplified cross-sectional view, is a portion of an improved perpendicular magnetic recording medium 11 according to the present disclosure, wherein reference numeral 2 indicates a non-magnetic substrate, reference numeral 3′ indicates a non-magnetic underlayer comprised of first, second, and third underlayers 3_{A}, 3_{B}, and 3_{C}, reference numeral 6 indicates at least one magnetically hard perpendicular recording layer with its magnetic easy axis perpendicular to the film plane, reference numeral 7 indicates a protective overcoat layer, and reference numeral 8 indicates a lubricant topcoat layer 8.

More specifically, according to the present disclosure, underlayer 3′ of medium 11, comprised of first, second, and third underlayers 3_{A}, 3_{B}, and 3_{C}, replaces the combination of non-magnetic adhesion layer 3, magnetically soft underlayer (SUL) 4, and non-magnetic interlayer 5 of the conventional perpendicular medium 1 shown in FIG. 1. The first underlayer 3_{A} is proximal the substrate 2 and is amorphous with a smooth surface; the second underlayer 3_{B} overlies the first underlayer 3_{A} and has a first crystallographic orientation, and the third underlayer 3_{C} overlies the second underlayer 3_{B} and has a second crystallographic orientation. The at least one perpendicular magnetic recording layer 6 overlies the third underlayer 3_{C} and has a crystallographic orientation similar to the second crystallographic orientation.

Preferably, the first crystallographic orientation of the second underlayer 3_{B} is fcc; the second crystallographic orientation of the third underlayer 3_{C} is hcp; and the at least one perpendicular magnetic recording layer 6 has an hcp (0002) crystallographic orientation.

According to embodiments of the present disclosure, the first underlayer 3_{A} with smooth surface and amorphous nature (which may comprise a plurality of amorphous layers) is from about 30 to about 1,000 Å thick and comprises 20-90 at. % Cr and up to about 80 at. % of at least one element selected from the group consisting of Ta, Ti, Zr, Nb, Hf; V, Mo, and W; the second underlayer 3_{B} is from about 5 to about 400 Å thick and comprises an element selected from the group consisting of Ag, Pt, Pd, Cu, and Au, and the first crystallographic orientation is fcc (111); the third underlayer 3_{c} is from about 1 monolayer to about 500 Å thick and comprises Ru or a Ru-based alloy; and the at least one perpendicular magnetic recording layer is from about 30 to about 350 Å thick and comprises Co and at least one element selected from the group consisting of Cr, Ni, Pt, Ta, B, Nb, O, Ti, Si, Mo, B, Cu, Ag, Ge, and Fe.

As before, substrate 2 is typically disk-shaped and comprised of a non-magnetic metal or alloy, e.g., Al or an Al-based alloy, such as Al—Mg having a Ni—P plating layer on the deposition surface thereof, or alternatively, substrate 2 is comprised of a suitable glass, ceramic, glass-ceramic, polymeric material, or a composite or laminate of these materials; protective overcoat layer 7 may comprise a diamond-like carbon (DLC) layer formed over magnetically hard layer 6; and a lubricant topcoat layer 8, e.g., comprised of a perfluoropolyether (PFPE) material, is formed over protective overcoat layer 7.

Each of layers 3_{A}, 3_{B}, 3_{C}, 6, and 7 of medium 11 may be formed in conventional manner, as by suitable thin film deposition techniques, including, but not limited to, DC or RF magnetron sputtering (static or pass-by), vapor deposition, ion plating, etc. The magnetically hard perpendicular recording layer 6 may, if desired, be formed as a granular layer via reactive sputter deposition, and the protective overcoat layer 7 may, if desired, be formed via ion beam deposition (IBD). Finally, the lubricant topcoat layer 8 may be formed in conventional manner, as by dip coating, spraying, etc.

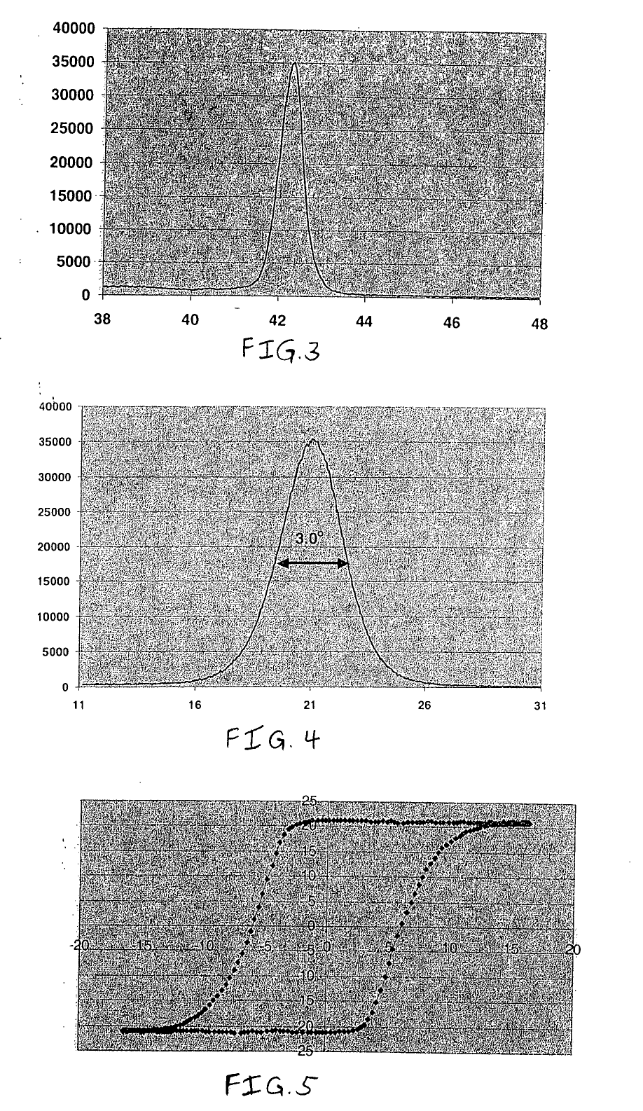

Adverting to FIG. 3, illustrated therein is a graph illustrating a θ-2θ X-ray diffraction scan of a CoPtOₓ perpendicular magnetic recording layer of a medium structured according to FIG. 2 and indicating presence of a desirable hcp (0002) crystallographic orientation. FIG. 4 is a graph illustrating an X-ray rocking curve scan of the CoPtOₓ perpendicular magnetic recording layer of the medium structured according to FIG. 2 and indicates a narrow full-width at half-maximum (FWHM) of 3°, demonstrating formation of an excellent hcp (0002) crystallographic orientation with a magnetization easy axis perpendicular to the film plane, suitable for perpendicular recording media. FIG. 5 is a graph illustrating a MOKE loop of a perpendicular magnetic recording medium structured according to FIG. 2 and unequivocally demonstrating magnetic properties suitable for perpendicular recording media.

It should be noted that the above-described embodiment of the disclosure is merely illustrative, and not limitative. For example, while the illustrated embodiment of FIG. 2 shows the perpendicular, magnetically hard recording layer 6 as a single layer, the disclosure is not limited thereto. Rather, layer 6 may comprise multiple perpendicular magnetic layers, either in adjacency or laminated with thin non-magnetic spacer layers. Finally, the composition of perpendicular recording layer 6 is not limited to the illustrated Co-based alloys, and other magnetic materials capable of forming thin film layers with magnetization easy axis perpendicular to the film plane may be utilized with appropriate underlayers according to the principles set forth in this disclosure.

In the previous description, numerous specific details are set forth, such as specific materials, structures, processes, etc., in order to provide a better understanding of the present disclosure. However, the present disclosure can be practiced without resorting to the details specifically set forth. In other instances, well-known processing materials and techniques have not been described in detail in order not to unnecessarily obscure the present disclosure.

Only the preferred embodiments of the present disclosure and but a few examples of its versatility are shown and described in the present disclosure. It is to be understood that the present disclosure is capable of use in various other combinations and environments and is susceptible of changes and/or modifications within the scope of the disclosed concept as expressed herein.

What is claimed is:

1. A perpendicular magnetic recording medium, comprising:
(a) a non-magnetic substrate having a planar surface; and
(b) a stack of thin film layers overlying said planar surface of said substrate and including at least one perpendicular magnetic recording layer with a magnetic easy axis perpendicular to the plane of said layer stack, wherein a magnetically soft underlayer (“SUL”) is not present in said layer stack.

2. The magnetic medium as in claim 1, wherein:
said layer stack includes first, second, and third underlayers beneath said at least one perpendicular magnetic recording layer.

3. The magnetic medium as in claim 2, wherein:
said first underlayer is proximal said substrate and is amorphous with a smooth surface;
said second underlayer overlies said first underlayer and has a first crystallographic orientation;
said third underlayer overlies said second underlayer and has a second crystallographic orientation; and
said at least one perpendicular magnetic recording layer overlies said third underlayer and has a crystallographic orientation similar to said second crystallographic orientation.

4. The magnetic medium as in claim 3, wherein:
said first crystallographic orientation is fcc;
said second crystallographic orientation is hcp; and
said at least one perpendicular magnetic recording layer has an hcp (0002) crystallographic orientation.

5. The magnetic medium as in claim 4, wherein:
said first underlayer is from about 30 to about 1,000 Å thick and comprises 20-90 at. % Cr and up to about 80 at. % of at least one element selected from the group consisting of Ta, Ti, Zr, Nb, Hf, V, Mo, and W.

6. The magnetic medium as in claim 4, wherein:
said first underlayer comprises a plurality of amorphous layers.

7. The magnetic medium as in claim 4, wherein:
said second underlayer is from about 5 to about 400 Å thick, comprises an element selected from the group consisting of Ag, Pt, Pd, Cu, and Au, and said first crystallographic orientation is fcc (111).

8. The magnetic medium as in claim 4, wherein:
said third underlayer is from about 1 monolayer to about 500 Å thick and comprises Ru or a Ru-based alloy.

9. The magnetic medium as in claim 4, wherein:
said at least one perpendicular magnetic recording layer is from about 30 to about 350 Å thick and comprises Co and at least one element selected from the group consisting of Cr, Ni, Pt, Ta, B, Nb, O, Ti, Si, Mo, B, Cu, Ag, Ge, and Fe.

10. The magnetic medium as in claim 1, wherein:
said substrate comprises a non-magnetic material selected from the group consisting of Al, Al—Mg alloy, other Al-based alloys, Ni—P plated Al or Al-based alloys, glass, ceramic, glass-ceramic, polymeric material, and composites or laminates of these materials.

11. The magnetic medium as in claim 1, wherein:
said layer stack includes a protective overcoat layer overlying said perpendicular magnetic recording layer and a lubricant topcoat layer overlying said protective overcoat layer.

12. A method of fabricating a perpendicular magnetic recording medium, comprising steps of:
(a) providing a non-magnetic substrate having a planar surface; and
(b) forming a stack of thin film layers overlying said planar surface of said substrate and including at least one perpendicular magnetic recording layer with a magnetic easy axis perpendicular to the plane of said layer stack, wherein a magnetically soft underlayer (“SUL”) is not present in said layer stack.

13. The method according to claim 12, wherein:
step (b) comprises forming said layer stack with first, second, and third underlayers beneath said at least one perpendicular magnetic recording layer.

14. The method according to claim 13, wherein:
step (b) comprises forming said layer stack such that said first underlayer is proximal said substrate and is amorphous with a smooth surface;
said second underlayer overlies said first underlayer and has a first crystallographic orientation;
said third underlayer overlies said second underlayer and has a second crystallographic orientation; and
said at least one perpendicular magnetic recording layer overlies said third underlayer and has a crystallographic orientation similar to said second crystallographic orientation.

15. The method according to claim 14, wherein:
step (b) comprises forming said layer stack such that said first crystallographic orientation is fcc;
said second crystallographic orientation is hcp; and
said at least one perpendicular magnetic recording layer has an hcp (0002) crystallographic orientation.

16. The method according to claim 15, wherein step (b) comprises forming said layer stack such that:
said first underlayer is from about 30 to about 1,000 Å thick and comprises 20-90 at. % Cr and up to about 80 at. % of at least one element selected from the group consisting of Ta, Ti, Zr, Nb, Hf, V, Mo, and W;
said second underlayer is from about 5 to about 400 Å thick, comprises an element selected from the group consisting of Ag, Pt, Pd, Cu, and Au, and said first crystallographic orientation is fcc (111);
said third underlayer is from about 1 monolayer to about 500 Å thick and comprises Ru or a Ru-based alloy; and
said at least one perpendicular magnetic recording layer is from about 30 to about 350 Å thick and comprises Co and at least one element selected from the group consisting of Cr, Ni, Pt, Ta, B, Nb, O, Ti, Si, Mo, B, Cu, Ag, Ge, and Fe.

17. The method according to claim 12, wherein:
step (a) comprises providing a substrate comprised of a non-magnetic material selected from the group consisting of Al, Al—Mg alloy, other Al-based alloys, Ni—P plated Al or Al-based alloys, glass, ceramic, glass-ceramic, polymeric material, and composites or laminates of these materials.

18. The method according to claim 12, further comprising steps of:
(c) forming a protective overcoat layer over said perpendicular magnetic recording layer; and
(d) forming a lubricant topcoat layer over said protective overcoat layer.

19. A perpendicular magnetic recording medium, comprising:
(a) a non-magnetic substrate having a planar surface; and
(b) a stack of thin film layers overlying said planar surface of said substrate, said layer stack including:
(i) a first underlayer in overlying contact with said planar surface, comprising Cr and at least one element selected from the group consisting of Ta, Ti, Zr, Nb, Hf, V, Mo, and W;
(ii) a second underlayer in overlying contact with said first underlayer, comprising an element selected from the group consisting of Ag, Pt, Pd, Cu, and Au;
(iii) a third underlayer in overlying contact with said second underlayer, comprising Ru or a Ru-based alloy; and
(iv) at least one perpendicular magnetic recording layer with a magnetic easy axis perpendicular to the plane of said layer stack in overlying contact with said third underlayer, comprising Co and at least one element selected from the group consisting of Cr, Ni, Pt, Ta, B, Nb, O, Ti, Si, Mo, B, Cu, Ag, Ge, and Fe.

20. The magnetic medium as in claim 19, wherein:
said first underlayer is amorphous with a smooth surface;
said second underlayer has a first crystallographic orientation;
said third underlayer has a second crystallographic orientation; and
said at least one perpendicular magnetic recording layer has a crystallographic orientation similar to said second crystallographic orientation.

21. The magnetic medium as in claim 20, wherein:
said first crystallographic orientation is fcc;
said second crystallographic orientation is hcp; and
said at least one perpendicular magnetic recording layer has an hcp (0002) crystallographic orientation.
